(19) United States
(12) Patent Application Publication
(10) Pub. No.: US 2009/0062466 A1
(43) Pub. Date: Mar. 5, 2009

(54) Polyolefin Composite Material And Method For Producing The Same

(76) Inventors: Jinyong Dong, Beijing (CN); Jiguang Liu, Beijing (CN); Zhichao Han, Beijing (CN); Dujin Wang, Beijing (CN)

Correspondence Address: BROWN & MICHAELS, PC;400 M & T BANK BUILDING, 118 NORTH TIOGA ST, ITHACA, NY, 14850, US

(21) Appl. No.: 11/718,256

(22) PCT Filed: Nov. 30, 2004
(86) PCT No.: PCT/CN04/01383

§ 371 Date: Apr. 30, 2007

(30) Foreign Application Priority Data
Nov. 5, 2004 (CN) 200410009753.5

(51) Int. Cl. C08L 23/08; C08L 23/12

(52) U.S. Cl. 525/54; 525/240; 525/232

(57) ABSTRACT

The present invention belongs to the field of polyolefin alloy preparation, and particularly relates to a polyolefin composite material in good form with adjustable composition and performances, produced by controlling a composite catalyst composed of Zieglar-Natta catalyst and metallocene catalyst to be catalytic by stage in the olefin polymerization reaction. This material is composed of propylene polymer and ethylene copolymer which is obtained by copolymerizing ethylene with alpha olefin or diolefin, wherein: the molar content of alpha olefin or diolefin in the ethylene copolymer is 0%˜60%, and the ethylene copolymer is 3˜80% by weight of the polyolefin composite material; the polyolefin composite material is in particle form, and the ethylene copolymer has a molecular weight distribution of 1˜6 and a glass transition temperature of −80˜0° C.; and the ethylene copolymer produced in the reaction is dispersed homogeneously in the propylene polymer particles to form the polyolefin composite material.

### FIELD OF THE INVENTION

The present invention belongs to the field of polyolefin alloy preparation, and particularly relates to a polyolefin composite material in good form with adjustable composition and performances, produced by controlling two catalytic components of a composite catalyst to be catalytic by stage in the olefin polymerization reaction.

### BACKGROUND OF THE INVENTION

By mixing different polymeric materials to form a polymer composite material (also referred to as polymer alloy), the polymeric composite material can have advantages of two or more polymers, and its performance can be improved effectively in many aspects. At present, there are mainly two methods to form polymer alloys. One method is a conventional mechanical blending method, and the other one is an in-situ synthesis method. It is difficult for the mechanical blending method to blend the polymers thoroughly, especially the non-polar polyolefin materials. The in-situ alloy synthesis method synthesizes one or more other polymers on or in the particles of a polymer, to realize the in-situ blending of different polymers. Since a second polymer is in the particles of a first polymer, not only a homogeneous polymer composite material can be obtained, but also polymers insoluble to each other can be mixed homogeneously, which is difficult to implement with the mechanical blending method. Presently, great attention has been paid to studies on the industrialization of polyolefin alloy, typically reactor granule technology (RGT).

Spheripol technique is one of the earliest industrialized RGT. This technique comprises: bulk polymerizing propylene; and then feeding polypropylene particles into the gas phase reactor, and copolymerizing ethylene and propylene in the polypropylene particles in the presence of the catalyst that is still active, so as to obtain a polyolefin material with high impact resistance. Spherilene technique, similar to Spheripol technique, is mainly used in the production of ethylene alloys. Interloy is a process in which polyolefin particles are first produced by using Ziegler-Natta catalyst; and then, in the particles, free radical graft copolymerization is carried out under radiation of a radioactive source, to synthesize a copolymer of polar monomers in the polymer particles. In Hivalloy technique, after polymerization in the presence of Ziegler-Natta catalyst, olefin is graft copolymerized with the matrix in the gaps formed in the polyolefin by using peroxide. It can implement graft polymerization of polar monomers or even non-olefin monomers such as styrene, acrylonitrile, acrylate and son on in polyolefin base, and thereby endows the polyolefin material with superior performances. Catalloy technique has most advantages of RGT, in which, a homopolymer is formed first, and then a second, third, and fourth monomers are introduced for polymerization, so as to obtain a multi-phase alloy of multiple polymers. This technique is a flexible multi-stage gas phase technique, and the performances of its products are comparable to those of nylon, polyethylene terephthalate (PET), acrylonitrile butadiene styrene (ABS), or polyvinylchloride (PVC). U.S. Pat. No. 5,698,642 proposes a multi-zone circulating reactor (MZCR) technique, which is much more advanced than Catalloy technique, and realizes ideal mixing of alloys and formation of a solid solution. However, all of above techniques are based on the heterogeneous catalyst (Ziegler-Natta catalyst), and most of them employ gas phase technique in the second polymerization stage. In addition, since Ziegler-Natta catalyst has poor copolymerization capability, and the molecular weight distribution of the polymer obtained through olefinic polymerization is wide, it is difficult to widely use those techniques in the molecular design of polyolefin materials, and it is also difficult for those techniques to improve the performances of alloys.

The metallocene catalyst for olefinic polymerization is a homogeneous catalyst developed in the recent years. It has single catalytic active site and strong copolymerization capability, and can catalyze the copolymerization of most monomers copolymerize, produce a polymer having a narrow molecular weight distribution and uniform distribution of the comonomers, and produce syndiotactic copolymers. Therefore, it can be used in molecular design of polymers. When metallocene catalyst is used to catalyze olefinic polymerization, the performances of the polymer can be predefined as required, and thereby the polymer can be synthesized more effectively and purposively. P. Galli and etc. in Montell Lab, Italy discloses a method of using Ziegler-Natta catalyst and metallocene catalyst together for RGT for the first time in “Journal of Applied Polymer Science”, P1831, Vol. 66, 1996. In this method, after homopolymerization of propylene, Ziegler-Natta catalyst is deactivated with water, r-EBTHZrCl₂ solution activated with alkylaluminoxane is added, and then gas-phase copolymerization of ethylene and propylene is carried out. However, this method is a method physically adsorbing metallocene catalyst, which can only be used in gas-phase process; if it is used in slurry process, the polymer form will be affected severely due to catalyst bleeding, and it is difficult to obtain desirable composite material. In addition, it is difficult for this method to ensure uniform distribution of catalyst or homogeneous mixing of the polymer produced in the second polymerization stage and the polyolefin produced in the first stage, and therefore, it is difficult to obtain a desirable polymeric composite material even in gas-phase process.

### SUMMARY OF THE INVENTION

An object of the present invention is to provide a polyolefin composite material.

Another object of the present invention is to provide a method for preparing a polyolefin composite material, which can ensure homogeneous mixing of the polymer produced in the second polymerization stage and the polyolefin produced in the first stage, and can effectively improve the performances of the polymeric composite material and obtain a desirable polymeric composite material.

Another object of the present invention is to provide a composite catalyst for olefinic polymerization or copolymerization, which has characteristics of both active Zieglar-Natta catalyst and active metallocene catalyst and ensures that the resulting polymer is in good form and has desirable performances as a result of molecular design.

The present invention utilizes a catalyst composed of non-homogeneous Zieglar-Natta and metallocene catalysts, and controls the non-homogeneous Zieglar-Natta catalyst to be catalytic and the metallocene catalyst to be non-catalytic in the first stage (olefinic polymerization), to produce spherical polyolefin particles. In the second polymerization stage, the present invention controls the non-homogeneous Zieglar-Natta catalyst to be substantially non-catalytic and activates the catalytic activity of metallocene compound to be catalytic in the ethylene homopolymerization or copolymerization, to take full advantage of molecular design ability of metallocene catalyst and carry out molecular design depending on the desired performances. Since the metallocene compound is dispersed homogeneously in the produced polypropylene as the non-homogeneous Zieglar-Natta catalyst breaks in the first polymerization stage, the second component (polymer) produced in the second polymerization stage will be dispersed in the polypropylene matrix homogeneously, so as to form a homogeneous polyolefin composite material.

The polyolefin composite material of the present invention comprises propylene polymer and ethylene copolymer which is obtained by copolymerizing ethylene with alpha olefin or diolefin, wherein, the molar content of alpha olefin or diolefin in the ethylene copolymer is 0%˜60%, and the ethylene copolymer is 3˜80% by weight of the polyolefin composite material.

The polyolefin composite material of the present invention is in particle form, and the ethylene copolymer has a narrow molecular weight distribution (PDI=1 to 6) and a low glass transition temperature (−80° C.˜0° C.). The ethylene copolymer produced in the reaction is dispersed homogeneously in the propylene polymer particles to form the polyolefin composite material, and the amount of alpha olefin or diolefin monomer in the ethylene copolymer is adjustable. Therefore, the melting point of the copolymer can be adjusted from highly amorphous form (without melting point) to 131° C.

The alpha olefin is 1-olefin having 3˜10 carbon atoms, and the diolefin has 4˜8 carbon atoms.

The method for preparing polyolefin composite material provided in the present invention comprises the following steps:
(1) adding propylene into a reactor, and carrying out bulk polymerization directly or slurry polymerization in an alkane solvent having 5˜10 carbon atoms and/or aromatic hydrocarbon solvent, in the presence of a composite catalyst composed of non-homogeneous Zieglar-Natta catalytic component and metallocene compound catalytic component, at a reaction temperature of 0° C.˜80° C., preferably 40° C.˜70° C., wherein, the metallocene compound catalytic component is 1%˜50%, preferably 10˜30% by weight of the composite catalyst. In the first olefinic polymerization stage, the non-homogeneous Zieglar-Natta catalyst is catalytic but the metallocene compound is controlled to be non-catalytic, such that the form of the polymer is controlled by the Zieglar-Natta catalyst in the olefinic polymerization to obtain a first polymer in good form and produce polyolefin particles.

In this step, alkyl aluminium or alkylaluminoxane can be further added as a cocatalyst in such an amount than the molar ratio of Al element to the Ti element in the non-homogeneous Zieglar-Natta catalytic component (Al/Ti) is 0˜1000, and preferably 50˜200.

In this step, an external electron donor can be added into the reaction system to control the isotacticity of the polymer, in an amount as 0˜100 times of the molar content of Ti element in the catalyst. The external electron donor can be alkoxysilane (e.g., diphenyldimethoxysilane, phenyltriethoxysilane, or 2,2,6,6-tetramethylpiperidine, etc.) or aromatic ester (e.g., ethyl benzoate or methyl p-methylbenzoate, etc.).

The metallocene catalyst is controlled to be non-catalytic in the reaction by adding a compound represented by the following formula:

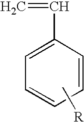

Wherein, R is alkyl having 1˜6 carbon atoms, ethenyl, Br, Cl or H or an inhibitor (e.g., alkyl aluminum compound having 3˜9 carbon atoms) to inhibit the catalytic activity of the metallocene catalyst into the solvent. The amount of addition is 0.1%˜20%, preferably 0.5%˜2% by volume of the solvent.
(2) after the polymerization in step (1) is completed, stopping the addition of the propylene monomer and introducing olefin monomer required for the second polymerization stage. The non-homogeneous Zieglar-Natta catalyst is controlled to be substantially non-catalytic, but the metallocene compound in dormant state is reactivated to be catalytic in the ethylene homopolymerization or copolymerization, so as to generate new polymer in the polymer particles produced in step (1), to obtain a polyolefin composite material in good form with controllable composition and performances.

After the first polymerization stage, in the second polymerization stage, a slurry polymerization reaction is carried out by adding a reacting monomer to the propylene polymer produced in step (1);

or, the liquid part in the propylene polymer produced in step (1) is removed, an alkane solvent having 5˜10 carbon atoms and/or aromatic hydrocarbon solvent is added, and then a reacting monomer is added for slurry polymerization;
or, the liquid part in the propylene polymer produced in step (1) is removed, and then a reacting monomer is added for gas-phase polymerization directly.

The reacting monomer can be an olefin or diolefin having 2˜10 carbon atoms.

The reaction temperature of above three methods is each 80° C.˜120° C., and preferably 90° C.˜100° C.

The metallocene catalyst in dormant state is reactivated by changing the reacting monomer and/or adding an activator in an amount of 1% by weight or more based on the total amount of the catalyst.

The activator is CₙHₙ₊₂; where, n=0˜2.

In the step (2), alkyl aluminum or alkylaluminoxane can be further added as a cocatalyst in such an amount that the molar ratio of the aluminum element to the metallic element of the metallocene compound in the composite catalyst is 0≠16,000.

In above two steps, the reaction pressure is 1-100 atm, and the alkyl aluminium or alkylaluminoxane has 1˜12 carbon atoms.

The composite catalyst composed of non-homogeneous Zieglar-Natta catalytic component and metallocene compound catalytic component is spherical and porous. It comprises two parts, i.e., the metallocene compound activated by alkyl aluminum or alkylaluminoxane, and the non-homogeneous Zieglar-Natta catalyst system; wherein, the alkyl aluminum or alkylaluminoxane has 1˜12 carbon atoms. The activated metallocene compound catalytic component is 1%˜50%, preferably 20%˜40% by weight of the composite catalyst.

Said non-homogeneous Zieglar-Natta catalyst system is a catalyst in spherical form, containing TICl₄ or TiCl₃ and internal electron donor, with magnesium chloride as the carrier.

The percentage contents of the components in the non-homogeneous Zieglar-Natta catalyst system are: Mg:10%˜30%, and preferably 15%˜22%; Ti:2%˜6%, and preferably 3%-4%; Cl:50%˜70%, and preferably 55%-65%; internal electron donor: 3%˜25%, and preferably 10%-20%.

In the present invention, the internal electron donor in the non-homogeneous Zieglar-Natta catalyst system is one or more of diisobutyl phthalate, dibutyl phthalate, diethyl succinate, fluorene diether, and a compound represented by the following general formula:

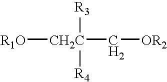

Wherein, R₁ and R₂ are methyl or ethyl; and R₃ and R₄ are alkyl or aryl having 1˜8 carbon atoms or

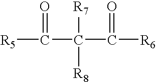

Wherein, R₅, R₆, R₇ and R₈ are alkyl or aryl having 1˜8 carbon atoms

In the activated metallocene compound metallocene compound to the Al element in alkyl aluminum or alkylaluminoxane is 1:50˜1:2000.

The alkyl aluminum or alkylaluminoxane has 1˜12 carbon atoms.

Said metallocene compound is a compound represented by the following general formula: Rₙ¹R²-n₂MCl₂;

where, R¹ and R² independently are Me₂Si(Ind)₂, Me₂Si(2-Me-4-Ph-Ind)₂, Me₂Si(2-Me-Ind)₂, Me(Me₃Si)Si(2-Me-4-Ph-Ind)₂, Me₂Si(IndR₂)₂, Et(Ind)₂, Me₂SiCp, MeCp, CpInd, Cp, Ph₂C(Cp)(Flu), Ph₂C(Cp)(2-Me₂NFlu) or Ph₂C(Cp)(2-MeOFlu); “R” in molecular formula Me₂Si(IndR₂)₂ is an alkyl having 1˜3 carbon atoms;

Where, Me is CH₃, Ind is indenyl, Ph is benzene ring, Et is ethyl, Cp is cyclopentadiene, and Flu is fluorene. M is Zr, Ti, Hf, V, Cr, Fe or La; and n=0˜2.

The composite catalyst for olefinic polymerization or copolymerization in the present invention is prepared as follows:

A mixed solution of alkyl aluminum or alkylaluminoxane and metallocene compound is mixed with the spherical Zieglar-Natta catalytic component; wherein, the alkyl aluminum or alkylaluminoxane has 1˜12 carbon atoms. Per 1 g Zieglar-Natta catalytic component is mixed with 1×10⁻⁶ mol˜5.6×10⁻⁴ mol, and preferably 2×10⁻⁵ mol˜1.0×10⁻⁴ mol of activated metallocene compound at a temperature of 0° C.˜80° C. Then the resulting mixture is agitated, filtered, washed with an alkane solvent having 5˜10 carbon atoms or aromatic hydrocarbon solvent, and then dried to obtain the composite catalyst. The preparation process is carried out in inert gas.

Said inert gas includes nitrogen gas, argon gas, or helium gas.

The metallocene compound in the present invention is activated as follows:

An alkyl aluminum or alkylaluminoxane having 1-12 carbon atoms is dissolved in a solvent, and then mixed with metallocene compound at a temperature of 0° C.˜90° C., and preferably 0° C.˜50° C., under stirring. The molar ratio of the metallic element in said metallocene to the Al element in said alkyl aluminum or alkylaluminoxane is 1:50˜1:2000, and preferably 1:80˜1:300. Said solvent is an alkane solvent having 5˜10 carbon atoms or aromatic hydrocarbon solvent. The preparation process is carried out in inert gas.

The spherical Zieglar-Natta catalyst is prepared with the method disclosed in patent document such as CN1110281A, CN1047302A, CN1091748A or U.S. Pat. No. 4,399,054, or prepared with the following method:

Spherical alcohol-MgCl₂ carrier prepared with alcohol having 2˜4 carbon atoms and MgCl₂ at a molar ratio of 1:1˜4:1 is put into a preparation flask, add TiCl₄ or TiCl₃ in an amount of 5 ml˜50 ml, and preferably 10 ml˜50 ml relative to per gram carrier, at a temperature of −20° C.˜10° C., and preferably −20° C.˜0° C. The resulting mixture is agitated, and heated up gradually. When the temperature is above 80° C., an internal electron donor is added thereto and then heated up to above 110° C. The resulting mixture is agitated and filtered, and 5 ml˜50 ml TiCl₄ or TiCl₃ is added thereto. The resulting mixture is agitated at 100° C.˜150° C. and filtered, without washing or followed by washing thoroughly with alkane (such as pentane, hexane, or heptane).

The present invention utilizes a composite catalyst composed of non-homogeneous Zieglar-Natta catalytic component and metallocene compound catalytic component, and controls the non-homogeneous Zieglar-Natta catalyst to be catalytic and the metallocene compound to be non-catalytic in the first olefinic polymerization stage, to produce spherical polyolefin particles. In the second polymerization stage, the non-homogeneous Zieglar-Natta catalyst is controlled to be non-catalytic, while metallocene compound is activated to be catalytic in the ethylene homopolymerization or copolymerization reaction, to take full advantage of the characteristics of said non-homogeneous metallocene catalyst to obtain a polymer in good form and take full advantage of molecular design ability of metallocene catalyst to carry out molecular design depending on the desired performances. In addition, a second or a third olefin homopolymer or copolymer is produced in the polypropylene particles produced in the first polymerization stage, so as to adjust the performances of the polymer alloy purposively. In the second polymerization stage, the second polymer component produced will be dispersed homogeneously in the polypropylene matrix, and therefore a polyolefin composite material with homogeneous composition can be formed. In examples of the present invention, a series of polyolefin alloy particles in good form and adjustable composition, with the components blended homogeneously, can be obtained.

### BRIEF DESCRIPTION OF THE DRAWINGS

FIG. 1 is a DMA diagram of the polymer obtained in Example 15 of the present invention.

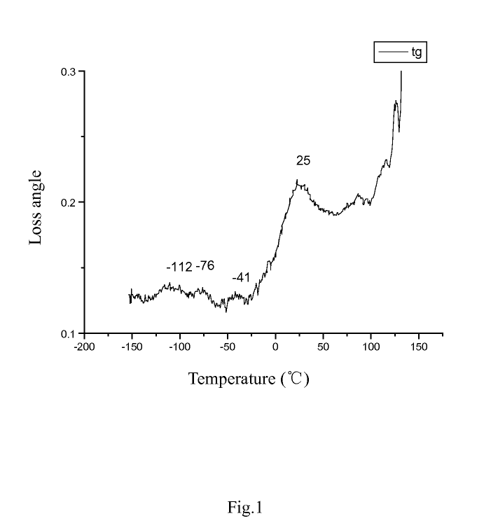

### DETAILED DESCRIPTION OF THE PREFERRED EMBODIMENTS

### Example 1

4 g spherical alcohol-MgCl₂ carrier (molar ratio of ethanol: MgCl₂=1:1) was added into a preparation flask, and then the flask was vacuumized and charged with argon gas. Then 200 ml TiCl₄ was added thereto at −20° C., followed by agitating, and heating up to 80° C. Next, 2 ml fluorene diether was added thereto, and agitated for 1.5 h. After vacuum filteration, 200 ml TiCl₄ was added and the resulting mixture was dried, to obtain the non-homogeneous Zieglar-Natta catalytic component.

0.028 mmol solid Me₂Si[2-Me-4-Naph-Ind]₂ZrCl₂ compound was put in a two-necked flask charged with argon gas, and 22.4 ml 2.5M toluene solution of methylaluminoxane (MAO) was added. Then, the resulting mixture was agitated, heated up to 90° C., and kept at 90° C. for 0.5 h. The above agitated metallocene compound was mixed with 2.8 g non-homogeneous Zieglar-Natta catalytic component in nitrogen gas at 0° C. The resulting mixture was agitated for 24 h, filtered, washed with methylbenzene and hexane respectively for 6-8 times (50 ml one time), and then dried in vacuum to obtain the composite catalyst A. The composition of said composite catalyst A was shown in Table 1.

### Example 2

2 g spherical alcohol-MgCl₂ carrier (molar ratio of ethanol:MgCl₂=4:1) was added into the preparation flask, and then the flask was vacuumized and charged with argon gas. Then, 100 ml TiCl₄ was added thereto at 0° C., followed by agitating, and heating up to 80° C. Next, 20 ml fluorene diether was added thereto, and agitated for 1.5 h. After filteration, 100 ml TiCl₄ was added, and the resulting mixture was heated up to 130° C., kept for 2 h, filtered and dried in vacuum, to obtain the non-homogeneous Zieglar-Natta catalytic component.

0.28 mmol solid Et(ind)₂ZrCl₂ compound was added in a two-necked flask charged with argon gas, and 112 ml 0.5M toluene solution of trimethyl aluminum (TMA) was added. Then, the resulting mixture was agitate for 24 h at 0° C.

The above metallocene compound solution was mixed with 0.5 g non-homogeneous Zieglar-Natta catalytic component in argon gas. The resulting mixture was agitated at 40° C. for 6 h, filtered, washed with methylbenzene for 6 times (30 ml per time), washed with 30 ml pentane, and dried in vacuum to obtain the composite catalyst B. The composition of said composite catalyst B was shown in Table 1.

### Example 3

4 g spherical alcohol-MgCl₂ carrier (molar ratio of ethanol:MgCl₂=2.6:1) was added into the preparation flask, and then the flask was vacuumized and charged with argon gas. Then, 160 ml TiCl₄ and 3.0 ml dibutyl phthalate were added at −10° C. The resulting mixture was agitated, heated up to 110° C., kept for 1.5 h, and washed with hexane for 4 times, to obtain the product in which the Ti content is 3.38%.

4 mmol solid Cp₂TiCl₂ compound was put in a two-necked flask charged with argon gas, and 143 ml 1.4M heptane solution of triisobutylaluminum (TIBA) was added thereto. The resulting mixture was agitated, heated up to 40° C., and kept for 5 h.

The above metallocene compound solution was mixed with 2 g non-homogeneous Zieglar-Natta catalytic component in nitrogen gas. The resulting mixture was kept at 80° C., agitated for 1 h, filtered in vacuum, washed with hexane for 6 times (30 ml for one time), and dried in vacuum, to obtain the composite catalyst C. The composition of said composite catalyst C was shown in Table 1.

### Example 4

The catalyst was prepared according to the method disclosed in CN1110281A.

24 g anhydrous MgCl₂, 400 ml white oil, and 50 ml ethanol were added in an autoclave, agitated, heated up to 120° C., and kept for 2 h at 120° C. Nitrogen gas was introduced into the autoclave till the pressure in the autoclave reached to 0.8 MPa. The drain valve was opened to spray the substances in the autoclave to 3 L mineral oil (200#) at stirring through a metal tube (length: 3 m, diameter: 1.2 mm). The solid precipitate was filtered, washed with hexane for 6 times, and dried at room temperature, to obtain the spherical alcohol-MgCl₂.

8 g above alcohol-MgCl₂ was added into 160 ml TiCl₄ at −10° C., agitated for 2.5 h, and heated up to 110° C. 1.4M dibutyl phthalate was added thereto, kept at 110° C. for 2 h, and filtered. 160 ml TiCl₄ was added thereto, and the resulting mixture was kept at 110° C. for 1.5 h, washed with hexane for 4 times, and dried in vacuum, to obtain the solid Zieglar-Natta catalytic component, in which the weight percentages were: Ti: 2.9, Mg: 19.1, Cl: 55, dibutyl phthalate: 7.1.

0.35 mmol solid Et(ind)₂ZrCl₂ compound was put in a two-necked flask charged with argon gas, and 280 ml 0.1M toluene solution of methylaluminoxane (MAO) was added thereto. Then, the resulting mixture was agitated, heated up to 40° C., and kept for 10 h.

The above metallocene compound solution was mixed with 2 g CS-2 non-homogeneous Zieglar-Natta catalytic component (manufactured by Liaoning Xiangyang Chemicals Group) in nitrogen gas. Then, the resulting mixture was kept at 40° C., agitated for 5 h, filtered, washed with decane for 8 times (30 ml for one time), washed with 30 ml pentane for one time, and dried, to obtain the composite catalyst D. The composition of said composite catalyst D was shown in Table 1.

### Example 5

10 g spherical alcohol-MgCl₂ carrier (molar ratio of isopropanol:MgCl₂=3.2:1) was added into the preparation flask, and then the flask was vacuumized and charged with argon gas. Then, 100 ml TiCl₄ and 5 ml ethyl succinate were added thereto at −20° C. The resulting mixture was agitated, heated up to 80° C., kept for 0.5 h, filtered, washed with heptane for 8 times (30 ml for one time) and washed with 30 ml hexane for one time, to obtain the product.

0.28 mmol solid rac-Et(Ind)₂HfCl₂ compound was put in a two-necked flask charged with argon gas, and 22.4 ml 2.5M toluene solution of methylaluminoxane (MAO) was added thereto. The resulting mixture was agitated mechanically, heated up to 40° C., and kept for 5 h.

The above non-homogeneous metallocene compound solution was mixed with 2 g non-homogeneous Zieglar-Natta catalytic component in nitrogen gas. The resulting mixture was kept at 60° C., agitated mechanically for 4 h, filtered in vacuum, washed with methylbenzene for 6 times, and dried in vacuum, to obtain the composite catalyst E. The composition of said composite catalyst E was shown in Table 1.

### Example 6

0.60 mmol solid Cp₂ZrCl₂ compound was put in a two-necked flask charged with argon gas, and 40 ml 1.4M dimethylbenzene solution of MAO was added, and agitated for 48 h at 0° C.

The above metallocene compound solution was mixed with 2 g CS-3 non-homogeneous Zieglar-Natta catalytic component (manufactured by Liaoning Xiangyang Chemicals Group) in nitrogen gas. The resulting mixture was kept at 80° C., agitated mechanically for 0.5 h, filtered in vacuum, washed with dimethylbenzene for 6 times (30 ml for one time), washed with 30 ml pentane for one time, and dried in vacuum, to obtain the composite catalyst F. The composition of said composite catalyst F was shown in Table 1.

TABLE 1

| | | | Percentages of the | | | |
|---|---|---|---|---|---|---|
| | Percentage of | | components in the non- | | | |
| | metallocene | | homogeneous Zieglar- | | | |
| | compound | | Natta catalytic component | | | |
| | component in | | | | | Internal |
| | the composite | | | Mg | | electron |
| Catalyst | catalyst (%) | Al/M | Ti % | % | Cl % | donor (%) |
| A (Example 1) | 26 | 2000 | 2.0 | 20 | 69 | 3 |
| B (Example 2) | 15 | 200 | 5.96 | 10 | 50 | 25 |
| C (Example 3) | 32 | 50 | 3.38 | 20 | 65 | 8 |
| D (Example 4) | 1 | 80 | 2.48 | 23 | 54 | 6 |
| E (Example 5) | 50 | 200 | 2.0 | 15 | 60 | 10 |
| F (Example 6) | 30 | 93 | 4.6 | 25 | 55 | 12 |

The remainder in the non-homogeneous Zieglar-Natta catalytic component is impurities.

### Preparation of Polyolefin Composite Material:

### Example 7

0.1 g catalyst A was added into a 500 ml autoclave, 2 ml styrene was added, and propylene was introduced therein under 100 atm at 0° C., to bulk polymerize for 20 min. The addition of propylene was stopped, and ethylene was added under 5 atm and was reacted for 10 min at 80° C.

### Example 8

0.1 g catalyst B was added into a 250 ml three-necked flask, 4 ml 1.8M heptane solution of trimethyl aluminum (TMA) and 100 ml toluene were added, and propylene was introduced therein under 1 atm at 40° C., to react for 1 h. Then, the solvent and propylene was removed in vacuum, 100 ml pentane and 9.2 ml 1.8M heptane solution of triethyl aluminum were added, and ethylene was introduced therein under 6 atm, to react for 10 min at 120° C.

### Example 9

0.1 g catalyst C was added into a 250 ml three-necked flask, 100 ml heptane, 2 ml divinylbenzene, and 26.7 ml 1.8M heptane solution of triethyl aluminum (TEA) were added, and propylene was introduced therein under 1 atm at 80° C., to react for 20 min. The addition of propylene was stopped, the product was filtered, and the solvent was removed. Ethylene was introduced under 1 atm and was reacted for 10 min at 90° C.

### Example 10

0.1 g catalyst D was added into a 250 ml three-necked flask, 8 ml 0.88M heptane solution of diphenyldimethoxysilane, 100 ml heptane, 0.1 ml para-methyl styrene, and 4 ml 1.8M heptane solution of TEA were added, and propylene was introduced under 1 atm at 60° C., to react for 1 h. Then, the solvent and propylene were removed in vacuum, 100 ml decane was added, and ethylene was introduced under 1 atm at 120° C., to react for 20 min.

### Example 11

0.1 g catalyst E was added into a 250 ml three-necked flask, 8 ml ethyl benzoate (1/50 heptane), 2 ml styrene, 100 ml decane, and 4 ml 1.8M heptane solution of TEA were added, and propylene was introduced under 1 atm at 80° C. and reacted for 1 h. The addition of propylene was stopped, 6 ml ethylene (gas) was introduced, and ethylene and propylene (6/1 molar ratio) were introduced under 5 atm at 100° C., to react for 10 min.

### Example 12

0.1 g catalyst F was added into a 250 ml three-necked flask, 20 ml styrene, 100 ml toluene, 4 ml 1.4M toluene solution of MAO were added, and propylene was introduced under 1 atm at 50° C., to react for 1 h. Then, the solvent and propylene were removed in vacuum, 100 ml pentane solvent and 4 ml 1.8M heptane solution of triisobutylaluminum (TIBA) were added, and a gas mixture of ethylene and propylene (6/1 molar ratio) were introduced, to react for 30 min. at 95° C.

### Example 13

0.1 g catalyst A was added into a 250 ml three-necked flask, 2 ml styrene, 100 ml heptane, and 4 ml 1.8M heptane solution of TEA were added, and propylene was introduced under 1 atm at 40° C., to react for 1 h. The addition of propylene was stopped, 10 ml butylenes was added, and ethylene was introduced to carry out a gas phase reaction for 10 min at 90° C.

### Example 14

0.1 g catalyst F was added into a 250 ml three-necked flask, 2 ml trimethyl aluminum, 100 ml heptane, and 4 ml 1.4M heptane solution of TEA were added, and propylene was introduced under 1 atm at 40° C., to react for 1 h. Then, the solvent and propylene were removed in vacuum, 100 ml toluene and 7.1 ml 1.4M toluene solution of MAO were added, and ethylene was introduced under 6 atm, to react for 30 min at 90° C.

### Example 15

0.1 g catalyst F was added into a 500 ml autoclave, 4 ml styrene, 200 ml heptane, and 4 ml 1.4M heptane solution of TEA were added, and propylene was introduced under 6 atm at 60° C., to react for 30 min. Then, 20 ml octylene was added, and ethylene was introduced under 6 atm, heated up to 90° C. and reacted for 1 min.

### Example 16

0.05 g catalyst F was added into a 500 ml autoclave, 3 ml styrene, 150 ml heptane, and 2 ml 1.4M heptane solution of TEA were added, and propylene was introduced under 6 atm at 60° C., to react for 30 min. Then, 6 ml decene was added, and ethylene was introduced under 6 atm, heated up to 90° C., and reacted for 10 min.

### Example 17

0.1 g catalyst F was added into a 500 ml autoclave, 4 ml styrene, 150 ml heptane, and 2 ml 1.4M heptane solution of TEA were added, and propylene was introduced under 6 atm at 60° C., to react for 30 min. Then, ethylene and propylene (1:1.2) were introduced under 6 atm, heated up to 90° C., and reacted for 30 min.

### Example 18

0.1 g catalyst F was added into a 500 ml autoclave, 3 ml styrene, 150 ml heptane, and 2 ml 1.4M heptane solution of TEA were added, and propylene was introduced under 6 atm at 60° C., to react for 30 min. Then, 6 ml butadiene was added, and ethylene was introduced under 6 atm, heated up to 95° C., and reacted for 10 min.

Table of polymer performances

| | | | | | | Content of | Content of | Melting | Melting |
|---|---|---|---|---|---|---|---|---|---|
| | | | | Reaction | Activity | copolymer | monomer* | point 1 | point 2 |
| Example | Solvent | Cocatalyst | Monomer | conditions | (g/g h) | (%) | (%) | (° C.) | (° C.) |
| Example 7 | — | — | Propylene, styrene; | 0°, 100 atm; | 20000 | 20 | 0 | 131 | 158 |
| | | | Ethylene | 80° C., 5 atm | | | | | |
| Example 8 | Heptane and | TMA | Propylene; | 40° C., 1 atm; | 280 | 40 | 0 | 131 | 156 |
| | pentane | TEA | Ethylene | 120° C., 6 atm | | | | | |
| Example 9 | Heptane | TEA | Propylene, divinylbenzene; | 80° C., 1 atm; | 560 | 50 | 0 | 130 | 156 |
| | | | Ethylene | 90° C., 1 atm | | | | | |
| Example 10 | Heptane, | TEA | Propylene, p-methyl | 60° C., 1 atm; | 180 | 40 | 0 | 130 | 158 |
| | Decane | | styrene; ethylene | 120° C., 1 atm | | | | | |
| Example 11 | Heptane | TEA | Propylene, styrene; | 80° C., 1 atm; | 260 | 60 | 8 | 121 | 156 |
| | | | Ethylene, propylene | 100° C., 5 atm | | | | | |
| Example 12 | Toluene, | MAO; | Propylene, phenethylene; | 50° C., 1 atm; | 160 | 40 | 6 | 118 | 158 |
| | Heptane | TIBA | Ethylene, propylene | 95° C., 1 atm | | | | | |
| Example 13 | Decane | TEA | Propylene, styrene; | 40° C., 1 atm; | 180 | 10 | 10 | 118 | 156 |
| | | | Ethylene, butylene | 120° C., 1 atm | | | | | |
| Example 14 | Heptane; | TEA, | Propylene, trimethyl | 40° C., 1 atm; | 460 | 80 | 0 | 130 | 158 |
| | Toluene | MAO | aluminum; Ethylene | 90° C., 6 atm | | | | | |
| Example 15 | Heptane | TEA | Propylene, styrene; | 60° C., 6 atm; | 600 | 3 | 60 | — | 152 |
| | | | Ethylene, octylene | 90° C., 6 atm | | | | | |
| Example 16 | Heptane | TEA | Propylene, styrene; | 60° C., 6 atm; | 580 | 30 | 16 | 122 | 156 |
| | | | Ethylene, Decene | 90° C., 6 atm | | | | | |
| Example 17 | Heptane | TEA | Propylene, styrene; | 60° C., 6 atm; | 620 | 70 | 40 | — | 155 |
| | | | Ethylene, propylene | 90° C., 6 atm | | | | | |
| Example 18 | Decane | TEA | Propylene, styrene; | 60° C., 6 atm; | 590 | 30 | 8 | 128 | 152 |
| | | | Ethylene, butadiene | 95° C., 6 atm | | | | | |

Note: *The monomer content is the percentage of other olefin monomers copolymerized with ethylene in the copolymer, except for ethylene.
The PE and PP content in the polymer is calculated as the consumed amount in the reaction.
The italic items indicate the monomers in the second reaction stage.

1. A polyolefin composite material, characterized in that it is composed of propylene polymer and ethylene copolymer which is obtained by copolymerizing ethylene with alpha olefin or diolefin, wherein:
the molar content of alpha olefin or diolefin in the ethylene copolymer is 0%˜60%, and the ethylene copolymer is 3˜80% by weight of the polyolefin composite material;
the polyolefin composite material is in particle form, and the ethylene copolymer has a molecular weight distribution of 1˜6 and a glass transition temperature of −80˜0° C.; and
the ethylene copolymer produced in the reaction is dispersed homogeneously in the propylene polymer particles to form the polyolefin composite material.

2. The material according to claim 1 characterized in that, said alpha olefin is 1-olefin having 3˜10 carbon atoms, and said diolefin has 4˜8 carbon atoms.

3. A method for preparing the polyolefin composite material according to claim 1, characterized in that it comprises the following steps:
(1) adding propylene into a reactor, and carrying out bulk polymerization directly and/or slurry polymerization in an alkane and/or aromatic hydrocarbon solvent, in the presence of a composite catalyst composed of non-homogeneous Zieglar-Natta catalytic component and metallocene compound catalytic component, at a reaction temperature of 0° C.˜80° C., wherein the metallocene compound catalytic component is 1%˜50% by weight of the composite catalyst, and in the first olefinic polymerization stage, the non-homogeneous Zieglar-Natta catalyst is catalytic and the metallocene compound is controlled to be non-catalytic, to obtain polyolefin particles; and
(2) after the polymerization in step (1) is completed, stopping the addition of the propylene monomer for polymerization in step (1), and
introducing a reacting monomer directly into the propylene polymer produced in step (1) for slurry polymerization;
removing the liquid part from the propylene polymer produced in step (1), adding alkane and/or aromatic hydrocarbon solvent, and introducing reacting monomer for slurry polymerization; or
removing the liquid part from the propylene polymer produced in step (1), and introducing a reacting monomer directly for gas-phase polymerization;
wherein said reacting monomer is an olefin or diolefin having 2˜10 carbon atoms; and
the non-homogeneous Zieglar-Natta catalyst is controlled to be substantially non-catalytic, and the metallocene compound in dormant state is reactivated to be catalytic in the ethylene homopolymerization or copolymerization, to obtain the polyolefin composite material.

4. The method according to claim 3 characterized in that, said alkane solvent is an alkane having carbon atoms.

5. The method according to claim 3 characterized in that, in step (1), an alkyl aluminum or alkylaluminoxane is further added as a cocatalyst, in such an amount that the molar ratio of the Al element to the Ti element in said non-homogeneous Zieglar-Natta catalytic component is: Al/Ti=0˜1,000.

6. The method according to claim 3 characterized in that, in step (1), an alkoxy silane or aromatic ester as an external electron donor is further added into the reaction system to control the degree of isotacticity of the polymer, in an amount as 0˜100 times of the mol content of Ti element in the catalyst.

7. The method according to claim 6 characterized in that, said alkoxy silane is diphenyldimethoxysilane, phenyltriethoxysilane, or 2,2,6,6-tetramethylpiperidine; and said aromatic ester is ethyl benzoate or methyl p-methylbenzoate.

8. The method according to claim 3 characterized in that, in the step (1), said metallocene catalyst is controlled to be non-catalytic by adding a compound represented by the following formula: 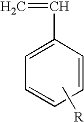
Where, R is an alkyl having 1˜6 carbon atoms, ethenyl, Br, Cl or H or an alkyl aluminum compound having 3˜9 carbon atoms into the solvent, in an amount of 0.1%˜20% by volume of the solvent.

9. The method according to claim 3 characterized in that, the reaction temperature in step (2) is 80° C.˜120° C.

10. The method according to claim 3 characterized in that, in step (2), the metallocene catalyst in dormant state is reactivated by changing the reacting monomer and/or adding an activator in an amount of 1% by weight or more of the catalyst,
wherein, the reacting monomer is an olefin or diolefin having 2˜10 carbon atoms, and the activator is CₙHₙ₊₂ (n=0˜2).

11. The method according to claim 3 characterized in that, in step (2), an alkyl aluminum or alkylaluminoxane is further added as a cocatalyst, in such an amount that the molar ratio of the Al element to the metallic element in the metallocene compound in said composite catalyst is 0˜16,000.

12. The method according to claim 11 characterized in that, said alkyl aluminum or alkylaluminoxane each has 1˜12 carbon atoms.

13. The method according to claim 3 characterized in that, said composite catalyst is composed of the metallocene compound activated by alkyl aluminum or alkylaluminoxane and the non-homogeneous Zieglar-Natta catalyst system, wherein the catalytic component in the activated metallocene compound is 1%˜50% by weight of the composite catalyst, and the alkyl aluminum or alkylaluminoxane has 1˜12 carbon atoms.

14. The method according to claim 13 characterized in that, said non-homogeneous Zieglar-Natta catalyst system is a spherical form catalyst containing magnesium chloride as a carrier, TiCl₄ or TiCl₃, and an internal electron donor;
wherein the internal electron donor is diisobutyl phthalate, dibutyl phthalate, ethyl succinate, or fluorene diether, or any compound represented by the following formula: 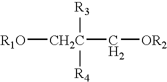
Where, R₁ and R₂ are methyl or ethyl; and R₃ and R₄ are an alkyl or aryl having 1˜8 carbon atoms
or 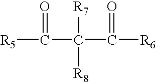
Where, R₅, R₆, R₇ and R₈ are an alkyl or aryl having 1˜8 carbon atoms.

15. The method according to claim 14 characterized in that, the percentages of the components in said non-homogeneous Zieglar-Natta catalyst system are: Mg:10%˜30%, Ti:2%˜6%, Cl:50%˜70%, and internal electron donor: 3%˜25%; and
said internal electron donor is diisobutyl phthalate, dibutyl phthalate, ethyl succinate, or fluorene diether, or any compound represented by the following formula: 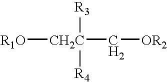
Where, R₁ and R₂ are methyl or ethyl; and R₃ and R₄ are an alkyl or aryl having 1˜8 carbon atoms
or 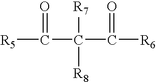
Where, R₅, R₆, R₇ and R₈ are an alkyl or aryl having 1˜8 carbon atoms.

16. The method according to claim 13 characterized in that, in said activated metallocene compound component, the molar ratio of the metallic element in said metallocene compound to the Al element in alkyl aluminum or alkylaluminoxane is 1:50˜1:2,000.

17. The method according to claim 13 characterized in that, said metallocene compound is a compound having the following general formula: Rₙ¹R₂₋ₙ²MCl₂;
in which, R¹ and R² independently are Me₂Si(Ind)₂, Me₂Si(2-Me-4-Ph-Ind)₂, Me₂Si(2-Me-Ind)₂, Me(Me₃Si)Si(2-Me-4-Ph-Ind)₂, Me₂Si(IndR₂)₂, Et(Ind)₂, Me₂SiCp, MeCp, Cplnd, Cp, Ph₂C(Cp)(Flu), Ph₂C(Cp)(2-Me₂NFlu) or Ph₂C(Cp)(2-MeOFlu), wherein “R” in molecular formula Me₂Si(IndR₂)₂ is an alkyl having 1˜3 carbon atoms, Me is CH₃, Ind is indenyl, Ph is benzene ring, Et is ethyl, Cp is cyclopentadiene, and Flu is fluorene;
M is Zr, Ti, Hf, V, Cr, Fe or La; and
n=0˜2.
